(19) United States
(12) Patent Application Publication
(10) Pub. No.: US 2026/0357592 A1
(43) Pub. Date: Nov. 12, 2026

(54) Method and System for Operating a Building Material System

(71) Applicant: Putzmeister Engineering GmbH, Aichtal (DE)

(72) Inventors: Hans-Bernd DUERR, Herrenberg (DE); Tobias HUTH, Stuttgart (DE); Florian LUTZ, Filderstadt (DE)

(21) Appl. No.: 19/120,892

(22) PCT Filed: Sep. 22, 2023
(86) PCT No.: PCT/EP2023/076208

§ 371 Date: Apr. 14, 2025

(30) Foreign Application Priority Data
Oct. 19, 2022 (DE) 10 2022 211 081.1

(51) Int. Cl. E04G 21/04; B28B 1/00; B28B 17/00; B33Y 10/00; B33Y 30/00; B33Y 50/02

(52) U.S. Cl. CPC E04G 21/0463; B28B 1/001; B28B 17/0081; B33Y 10/00; B33Y 30/00; B33Y 50/02

(57) ABSTRACT

A method operates a building material system having a discharge device, a distribution boom and controllable drive devices. The discharge device is designed for discharging building material out of the building material system. For positioning the discharge device, the distribution boom has adjustable boom segments. The drive devices are designed for driving the boom segments. The method includes the steps of: a) identifying a model of the building material system by controlling the drive devices with input signals for exciting movements of the distribution boom and by detecting output signals caused by the excited movements; b) determining, in particular calculating, a controller in dependence on the identified model; and c) controlling the building material system, in particular for reaching and/or for holding a setpoint position of the distribution boom, by the determined controller.

### FIELD OF ART

The invention relates to a method and a system for operating a building material system.

### BACKGROUND AND SUMMARY

The invention is based on the object of providing a method and a system each for operating a building material system, each of which has improved properties.

The invention achieves this object by providing a method and a system described in the independent claims. Advantageous refinements and/or embodiments of the invention are described in the dependent claims.

The method according to the invention is for operating a building material system. The building material system comprises a discharge device, a distributor boom, and actuatable drive devices. The discharge device is designed for discharging building material from the building material system. The distributor boom comprises adjustable or movable boom segments, in particular in relation to one another, for positioning the discharge device. The drive devices are designed for driving the boom segments, in particular for their adjustment. The method comprises the following steps: a) identifying one, in particular at least one, model of the building material system, in particular a boom model of the distributor boom, by means of actuating the drive devices using input signals to excite movements of the distributor boom, in particular the boom segments, and by means of detection of output signals caused by the excited movements. b) determining, in particular calculating one, in particular at least one, controller, in particular a boom controller, depending on, in particular at least on, the identified model. c) controlling the building material system, in particular to reach and/or maintain a target position of the distributor boom by means of, in particular at least, the determined controller.

This, in particular step a), enables the model to be able to be independent of modeling errors and/or, in particular therefore, close to a real behavior of the building material system. Alternatively or additionally, in particular therefore, this enables, in particular step b), good operation, in particular control, of the building material system, in particular by means of the controller adapted to the real behavior of the building material system. In particular, the control for reaching and/or maintaining can enable stabilizing and/or compensating for disturbances. Therefore, this can enable accurate positioning, in particular of a boom tip of the distributor boom and therefore, of the discharge device.

In particular, the method, the operation, the discharge, the positioning, the driving, the identifying, the actuating, the detecting, the determining, and/or the controlling can be automatic or independent.

The building material system can be mobile, in particular drivable, in particular an auto building material system.

Actuatable can be hydraulically and/or electrically actuatable.

The term “actuators” can be used synonymously for the term “drive devices”.

The term “comprises” or “has” can be used synonymously for the term “includes”.

The term “configured” can be used synonymously for the term “designed”.

The building material can be a thick material, in particular concrete, bentonite, cement, mortar, screed, and/or plaster.

The distributor boom can be designed for positioning the discharge device and/or as adjustable.

The term “section” can be used synonymously for the term “segment”.

Step a) can be designated as system identifying or identification.

The identifying can be experimental and/or by means of ascertaining a quantitative dependence of the output signals on the input signals.

The model can be mathematic and/or dynamic and/or can describe the building material system in the frequency range, such as a Bode diagram or a state space representation, and/or can comprise parameters, in particular values of the parameters. In particular, the model can be a differential equation system describing a relationship between the input and output signals. The input signals and/or the output signals can be for the system identifying and/or can be defined or specified and/or can be physical and/or different, in particular of different types, and/or can have values.

The term “test” can be used synonymously for the term “input”.

The term “causing” can be used synonymously for the term “exciting”.

The term “measuring” can be used synonymously for the term “detecting”.

The term “response” can be used synonymously for the term “output”.

The output signals can result due to or depending on the excited movements or the input signals.

The detection can be by means of at least one, in particular electric, sensor device, in particular sensor devices, of the building material system.

The term “generating” or “designing” can be used synonymously for the term “determining”.

The controller can have a model or a type and/or parameters, in particular values of the parameters.

The term “based on” or “on the basis of” can be used synonymously for the term “depending on”.

The target position can have values and/or can be changeable.

The control can include, in particular be, a control of the distributor boom. The term “pose” can be used synonymously for the term “position”.

Step b) can be carried out chronologically after step a). Alternatively or additionally, step c) can be carriedout chronologically after step b).

In one refinement of the invention, the input signals are for exciting a frequency spectrum of the distributor boom, in particular the boom segments. This enables the model to be able to be very close to the real behavior of the building material system. In particular, this can enable intrinsic vibrations or resonances of the building material system, in particular the distributor boom, to be able to be excited. In particular, the building material system, in particular the distributor boom, can be oscillating.

In particular the input signals can include, in particular can be, white noise and/or chirp. Moreover, reference is made to the technical literature.

In one refinement of the invention, the input signals include jumps, in particular of different durations and/or different amplitudes. In particular, the input signals are the jumps. Surprisingly, this enables relatively weak stressing of the building material system, in particular in comparison to white noise and/or chirp.

In one refinement of the invention, step a) is carried out, in particular multiple times or repeatedly, for various positions of the distributor boom, in particular the boom segments, and/or for various loads of the distributor boom with building material to identify different models of the building material system. Step b) includes: determining, in particular only, the, in particular single, controller depending on the identified models. This enables the, in particular single, determined controller to be able to be robust or stable and/or, in particular therefore, fixed, and/or to be able to be switched or changed between specific controllers, in particular depending on robustness barriers or limits determined depending on the positions and/or the loads. In particular, the positions can be an arch position, a horizontal position, a vertical position, and/or a Z position and/or at least two, in particular at least five, in particular at least ten, positions. Additionally or alternatively the loads can be at least two, in particular at least five, in particular at least ten, loads.

In one refinement of the invention, step a) is carried out by means of a controller simpler than the controller determined in step b), in particular a P controller (proportional controller). Additionally or alternatively, the model includes a linear model. In particular, the model is the linear model. Furthermore, additionally or alternatively, the controller determined in step b) includes a linear controller, in particular an LQ controller (linear-quadratic controller), an LQG controller (linear-quadratic-Gaussian controller), an LPV controller (linear-parameter-variable or variant controller), and/or a robust controller, in particular an H-infinite controller, and/or a model-predictive controller. In particular, the determined controller is the linear controller and/or the robust controller and/or the model-predictive controller. This, in particular the simple controller, enables the building material system, in particular the distributor boom, to stabilize. In particular, the simple controller can be referred to as a stabilizing controller. Additionally or alternatively, this enables the linear model in particular to come close enough to the real behavior of the building material system. In particular, the linear model can be a linear or conventional differential equations system. Additionally or alternatively, the building material system can be linear and/or time-invariant. Furthermore, additionally or alternatively, the controller enables simple determination and/or very good operation, in particular control, of the building material system, in particular for various positions of the distributor boom and/or for various loads of the distributor boom with building material. Moreover, reference is made to the technical literature.

In one refinement of the invention, the building material system and/or the distributor boom have/has a pivot mechanism and/or pivot joints for adjusting the boom segments. Additionally or alternatively, the output signals are representative of rotational angle positions, in particular and rotational angle positioning speeds, of the boom segments. In particular, the output signals are the rotational angle positions, in particular and the rotational angle positioning speeds. Furthermore, additionally or alternatively, the controller includes a rotational angle controller. In particular, the controller is the rotational angle controller. In particular, one of the pivot joints can be at a non-free or fixed end or boom base of the distributor boom and/or the pivot mechanism. Additionally or alternatively, an axis of rotation of the pivot mechanism can be vertical. Furthermore, additionally or alternatively, axes of rotation of the pivot joints can be horizontal and/or parallel, in particular in relation to one another. Furthermore, additionally or alternatively, the term “characteristic” can be used synonymously for the term “representative”. Furthermore, additionally or alternatively, the rotational angle controller can be referred to as a pivot mechanism and/or pivot joint controller.

In one refinement of the invention, the building material system includes a parallel robot, in particular a delta robot. The distributor boom is designed for the positioning, in particular the rough positioning, of the parallel robot, in particular at the boom tip of the distributor boom. The parallel robot is designed for the positioning, in particular the fine positioning, of the discharge device. The drive devices are designed for driving the parallel robot, in particular of robot arm devices of the parallel robot. In particular, step a) includes: identifying at least the model of the building material system, in particular a robot model of the parallel robot, by means of the actuation of the drive devices using the input signals to excite movements of the parallel robot and by means of the detection of the output signals caused by the excited movements, in particular during a standstill of the distributor boom. In particular, the output signals are representative of a position, in particular a translational position, and/or an alignment, in particular a rotational alignment, of the parallel robot and/or the discharge device with respect to a building environment of the building material system. In particular, the output signals are the position and/or the alignment. Step b) includes: determining at least the controller, in particular a robot controller, depending on at least the identified model. Step c) includes: controlling the building material system, in particular to reach and/or maintain a target position and/or a target alignment of the parallel robot, by means of at least the determined controller. The parallel robot enables compensation for a positioning inaccuracy of the distributor boom. This therefore enables very accurate positioning of the discharge device. In particular, the parallel robot can be a hexapod. Additionally or alternatively, the term “manipulator” can be used synonymously for the term “robot”. Furthermore, additionally or alternatively, the distributor boom can be referred to as a serial robot. Furthermore, additionally or alternatively, the boom tip can be a free end of the distributor boom. Furthermore, additionally or alternatively, the parallel robot can be rotatable in relation to the distributor boom, in particular the boom tip, in particular around a vertical axis of rotation. Furthermore, additionally or alternatively, the term “orientation” can be used synonymously for the term “alignment”. Furthermore, additionally or alternatively, the target position and/or the target alignment can have values and/or can be variable. Furthermore, additionally or alternatively, the boom model and the robot model can be different. Furthermore, additionally or alternatively, the boom controller and the robot controller can be different. Furthermore, additionally or alternatively, the control can include, in particular be, a control of the parallel robot. Furthermore, additionally or alternatively, the standstill of the distributor boom can be controlled or uncontrolled.

In one embodiment of the invention, the detection of an output signal of the output signals caused by the excited movements of the parallel robot is carried out by means of an optical measuring device, in particular a laser tracker. This enables a high level of accuracy, in particular in the 1 mm (millimeter) range. In particular, the measuring device can be electrical and/or for an absolute position. Additionally or alternatively, the measuring device can be independent and/or external from the distributor boom and/or the parallel robot.

In one embodiment of the invention, step b) includes: determining the controller for the control of the distributor boom for the positioning of the discharge device such that the parallel robot reaches its center position and/or its center alignment. In particular, step a) includes: identifying the model including the boom model of the distributor boom and the robot model of the parallel robot. Step b) includes: determining the boom controller for a, in particular the, control of the distributor boom depending on the identified boom model and the robot controller for a, in particular the, control of the parallel robot depending on the identified robot model. Identifying a system model of the building material system by means of actuation of the drive devices using input signals determining a tip position of the boom tip by means of the determined boom controller, while the parallel robot is controlled by means of the determined robot controller to reach a target position of the discharge device, and by means of detecting output signals including a deviation of an actual position of the parallel robot from the center position and/or an actual alignment of the parallel robot from the center alignment. Determining the controller depending on the identified system model. Step c) includes: controlling the distributor boom for the positioning of the discharge device by means of the determined controller (tracking controller), and in particular the parallel robot for the positioning of the discharge device by means of the determined robot controller. This enables a large margin or working room of the parallel robot to be ensured. In particular, the center position can be defined or specified by a center of an area of possible positions of the parallel robot, in particular delimited by mechanical stops. Additionally or alternatively, the center alignment can be defined or specified by a center of a range of possible alignments of the parallel robot, in particular delimited by mechanical stops. Furthermore, additionally or alternatively, the center position and/or the center alignment can have values. Furthermore, additionally or alternatively, step b) can be referred to as system identifying or identification. Furthermore, additionally or alternatively, the system model can be different from the boom model and/or the robot model. Furthermore, additionally or alternatively, the controller can be different from the boom controller and/or the robot controller. Furthermore, additionally or alternatively, the controller can be superimposed or superior to the boom controller and/or can be referred to as a system controller. Furthermore, additionally or alternatively, the tip position can be a target tip position and/or can be variable. Furthermore, additionally or alternatively, the target position of the discharge device can be variable. Furthermore, additionally or alternatively, the term “difference” can be used synonymously for the term “deviation”. Furthermore, additionally or alternatively, the actual position and/or the actual alignment can be variable.

In one embodiment of the invention, the building material system includes the pivot mechanism and an inertial sensor device. The inertial sensor device is arranged at an end of the distributor boom opposite to the pivot mechanism, in particular the parallel robot, and/or the discharge device for detecting an output signal of the output signals caused by a movement of the movements of the distributor boom excited by a rotation of the pivot mechanism. This enables a high level of accuracy. In particular, the term “inertial measuring unit” can be used synonymously for the term “inertial sensor device”. Additionally or alternatively, the inertial sensor device can be electrical and/or can include, in particular can be, an acceleration and/or rotation rate sensor. Furthermore, additionally or alternatively, the output signal can be representative of an acceleration and/or a rotation rate, in particular can be the acceleration and/or the rotation rate. Furthermore, additionally or alternatively, the inertial sensor device can be independent and/or external from the distributor boom and/or the parallel robot and/or the measuring device. Furthermore, additionally or alternatively, the end can be a last boom segment, in particular the boom tip.

In one refinement of the invention, the discharge device includes a printhead. In particular, the discharge device is the printhead. The printhead is designed for discharging building material from the building material system and for shaping building material to form a strand of building material, in particular for 3D printing of a structural part. This method enables forming the strand accurately in position, in particular with respect to the building environment. In particular, the building material system can be referred to as a printing system. Additionally or alternatively, the shaping and/or the 3D printing can be automatic. Furthermore, additionally or alternatively, the building material can be concrete, in particular fresh concrete, and/or thixotropic and/or compact or dimensionally stable, in particular during the discharge. Furthermore, additionally or alternatively, the strand, which is in particular discharged and/or formed, can be continuous or extend in a length, in particular a specific length. Furthermore, additionally or alternatively, the strand can be deposited or discharged, in particular layer by layer, on a strand or an already formed strand, and/or a further strand can be deposited or discharged on the strand, in particular layer by layer. Furthermore, additionally or alternatively, the structural part can be three-dimensional and/or can be a building structural part and/or a wall and/or a ceiling. Furthermore, additionally or alternatively, the strand, in particular a width of the strand, can have a wall and/or ceiling thickness, in particular a total wall and/or ceiling thickness. Furthermore, additionally or alternatively, the 3D printing can be referred to as additive manufacturing.

In one refinement, in particular one embodiment, of the invention, step c) includes: controlling the building material system depending on data, in particular a building or construction plan, in particular in a storage device of the building material system, of a, in particular the, structural part to be built, in particular to be printed. This enables errors to be reduced or even avoided during the building.

In one refinement of the invention, the method includes the following step: discharging building material by means of the discharge device during the control of the building material system, in particular for the positioning of the discharge device, for distributing building material.

In one refinement of the invention, the building material system includes a conveyor line. The conveyor line is arranged along the distributor boom to guide building material to the discharge device. Additionally or alternatively, the building material system includes a building material pump. The building material pump is designed to convey building material, in particular through the conveyor line, to the discharge device, in particular for the discharge of conveyed building material. In particular, the method includes the following step: conveying building material by means of the building material pump during the control of the building material system, in particular for the positioning of the discharge device. In particular, the conveyor line can be adjustable and/or can include, in particular can be, a pipeline. Additionally or alternatively, the conveying can be automatic. Furthermore, additionally or alternatively, the building material pump can be discontinuous, in particular a piston pump, in particular a two-piston pump, in particular having a transfer tube.

The system according to the invention is for, in particular is designed for, the operation of a, in particular the, building material system. The system includes an identification, determination, and control device. The identification, determination, and control device is designed for the, in particular automatic, performance of a, in particular the, method as described above. In particular, the system includes the building material system. The system can enable the same advantage(s) as the above described method. In particular, the system, in particular the identification, determination, and control device, can be electrical and/or can include a computing device, in particular a processor, and/or a storage device, in particular a computer.

Further advantages and aspects of the invention result from the claims and from the description of exemplary embodiments of the invention, which are explained hereinafter on the basis of the figures.

### BRIEF DESCRIPTION OF THE DRAWINGS

FIG. 1 schematically shows a system according to an embodiment of the invention including a building material system and a method for operating the building material system;

FIG. 2 schematically shows a discharge device and a building material pump of the building material system of FIG. 1 during operation;

FIG. 3 schematically shows a structural part which is 3D-printed by means of the building material system of FIG. 1 from formed strands of building material;

FIG. 4 schematically shows a flow chart of the method of FIG. 1;

FIG. 5 schematically shows a further flow chart of the method of FIG. 1;

FIG. 6 schematically shows a graph of an amplitude of jumps over time of the method of FIG. 1; and

FIG. 7 schematically shows still a further flow chart of the method of FIG. 1.

### DETAILED DESCRIPTION OF THE DRAWINGS

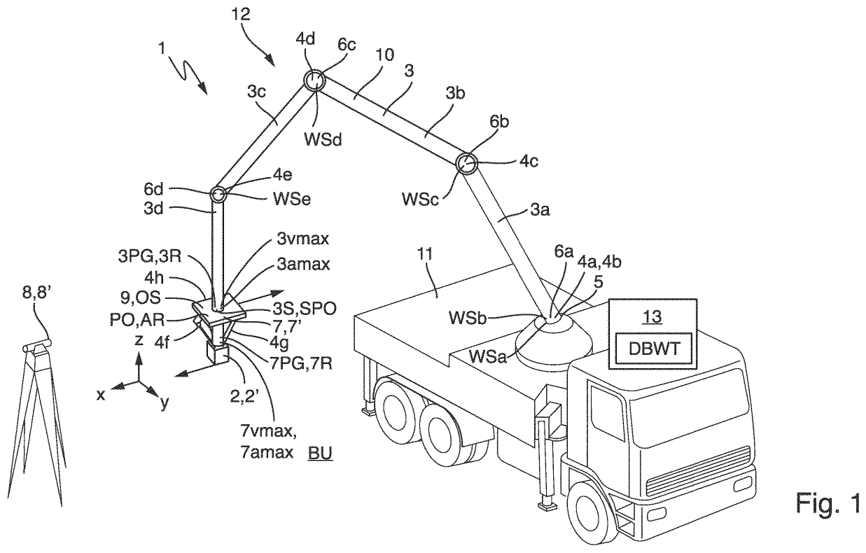

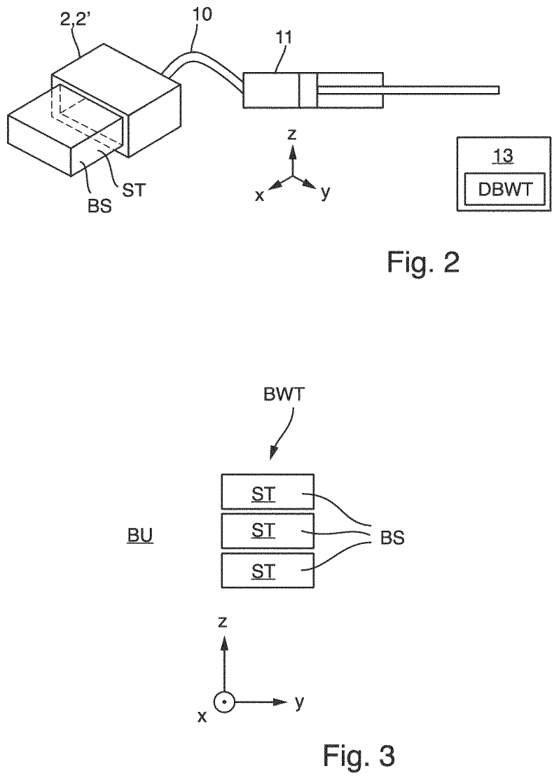

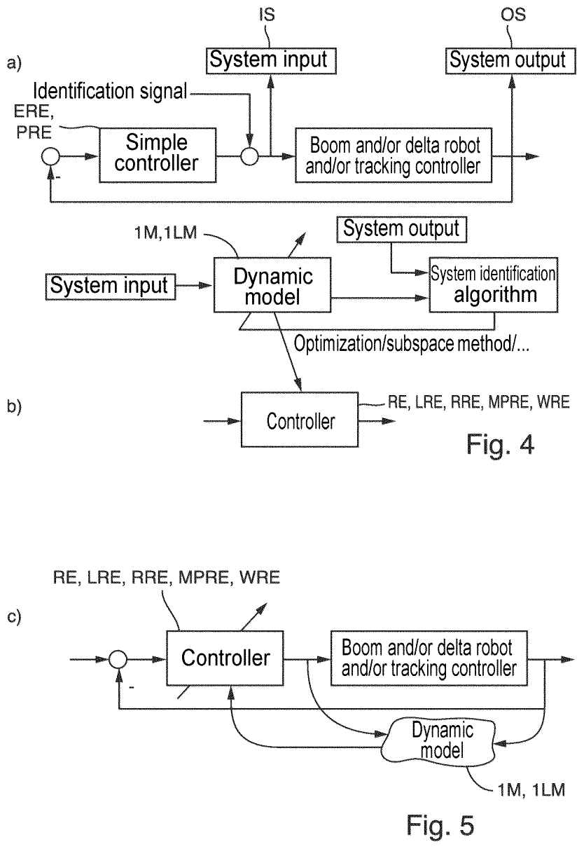

FIGS. 1, 2, 4, 5, and 7 show a method and a system 12 for operating a building material system 1.

The system 12 includes an identification, determination, and control device 13. The identification, determination, and control device 13 is designed to perform, in particular performs, the method.

In particular, the system 12 includes the building material system 1.

The building material system 1 includes a discharge device 2, a distributor boom 3, and actuatable drive devices 4a, 4b, 4c, 4d, 4e, 4f, 4g, 4h. The discharge device 2 is designed to discharge, in particular discharges, building material BS from the building material system 1. The distributor boom 3 includes adjustable boom segments 3a, 3b, 3c, 3d for positioning the discharge device 2, in particular positions it. The drive devices 4a-e are designed for driving the boom segments 3a-d, in particular drive them. The method includes the following steps: a) identifying a model 1M of the building material system 1, in particular a boom model 3M of the distributor boom 3, by means of actuation of the drive devices 4a-e using input signals IS to excite movements of the distributor boom 3 and by means of detection of output signals OS caused by the excited movements. b) determining, in particular calculating a controller RE, in particular a boom controller 3RE, depending on the identified model 1M, in particular the identified boom model 3M. c) controlling the building material system 1, in particular to reach and/or to maintain a target position of the distributor boom 3, by means of the determined controller RE, in particular the determined boom controller 3RE.

In the exemplary embodiment shown, the distributor boom 3 includes four boom segments 3a-d. In alternative exemplary embodiments, the distributor boom can include at least three boom segments.

In detail, the building material system 1 includes a parallel robot 7, in particular a delta robot 7′. The distributor boom 3 is designed, in particular positioned, for positioning the parallel robot 7, in particular at a boom tip 3S of the distributor boom 3. The parallel robot 7 is designed, in particular positioned, for positioning the discharge device 2. The drive devices 4f-h are designed for driving the parallel robot 7, in particular drive it. In particular, step a) includes: identifying at least the model 1M of the building material system 1, in particular a robot model 7M of the parallel robot 7, by means of the actuation of the drive devices 4f-h using the input signals IS to excite movements of the parallel robot 7 and by means of the detection of the output signals OS caused by the excited movements. In particular, the output signals OS are representative of a position PO and/or an alignment AR of the parallel robot 7 and/or the discharge device 2 with respect to a building environment BU of the building material system 1. In particular, the output signals OS are the position PO and/or the alignment AR. Step b) includes: determining at least the controller RE, in particular a robot controller 7RE, depending on at least the identified model 1M, in particular the identified robot model 7M. Step c) includes: controlling the building material system 1, in particular to reach and/or maintain a target position and/or a target alignment of the parallel robot 7, by means of at least the determined controller RE, in particular the determined robot controller 7RE.

In detail, step b) includes: determining the controller RE for the control of the distributor boom 3 for the positioning of the discharge device 2 such that the parallel robot 7 reaches its center position and/or its center alignment. In particular, step a) includes: identifying the model 1M including the boom model 3M of the distributor boom 3 and the robot model 7M of the parallel robot 7. Step b) includes: determining the boom controller 3RE for the control of the distributor boom 3 depending on the identified boom model 3M and the robot controller 7RE for the control of the parallel robot 7 depending on the identified robot model 7M. Identifying a system model SM of the building material system 1 by means of actuation of the drive devices 4a-e using input signals IS determining a tip position SPO of the boom tip 3S by means of the determined boom controller 3RE, while the parallel robot 7 is controlled to reach a target position of the discharge device 2 by means of the determined robot controller 7RE, and by means of detection of output signals OS including a deviation DI of an actual position of the parallel robot 7 from the center position and/or an actual alignment of the parallel robot 7 from the center alignment. Determining the controller RE depending on the identified system model SM. Step c) includes: controlling the distributor boom 3 for the positioning of the discharge device 2 by means of the determined controller RE, and in particular the parallel robot 7 for the positioning of the discharge device 2 by means of the determined robot controller 7RE.

Furthermore, the input signals IS are for exciting a frequency spectrum of the distributor boom 3, in particular for the identification of the boom model 3M, and/or of the parallel robot 7, in particular for the identification of the robot model 7M.

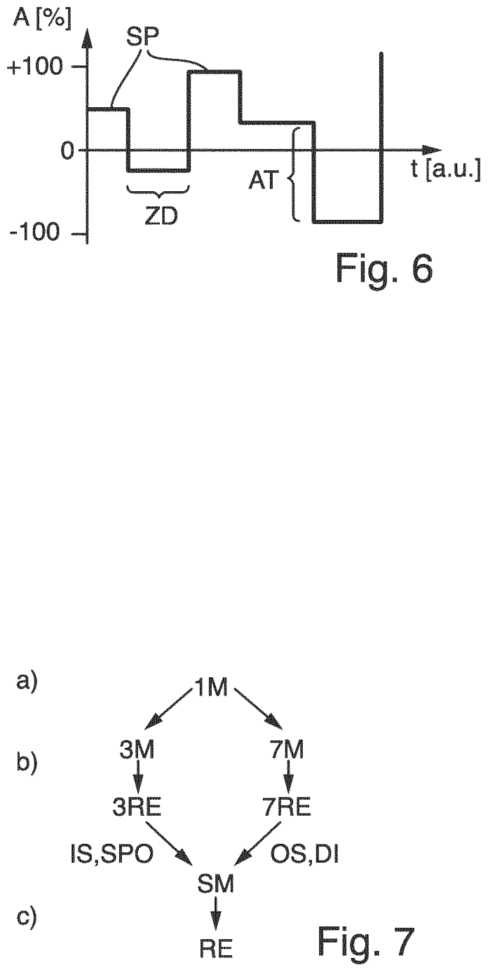

In addition, the input signals IS include jumps SP, in particular of differing duration ZD and/or differing amplitude AT, in particular for the identification of the boom model 3M. In particular, the input signals IS are the jumps SP, in particular for the identification of the robot model 7M. This is shown in FIG. 6.

Furthermore, step a) is performed for various positions of the distributor boom 3 and/or for various loads of the distributor boom 3 with building material BS for the identification of different models 1M of the building material system 1, in particular different boom models 3M of the distributor boom 3. Step b) includes: determining, in particular only, the, in particular single, controller RE, in particular the boom controller 3RE, depending on the identified models 1M, in particular the identified boom models 3M.

Moreover, step a) is performed by means of a controller ERE, in particular a P controller PRE, which is simpler than the controller RE determined in step b). Additionally or alternatively, the model 1M includes a linear model 1LM. In particular, the model 1M is the linear model 1LM. Furthermore, additionally or alternatively, the controller RE determined in step b) includes a linear controller LRE, in particular an LQ controller, an LQG controller, an LPV controller, and/or a robust controller RRE, in particular an H-infinite controller, and/or a model-predictive controller MPRE. In particular, the determined controller RE is the linear controller LRE and/or the robust controller RRE and/or the model-predictive controller MPRE.

In other words, the input signals are not directly output, but rather disturb the simpler controller in order to maintain the working range of the drive devices and as a whole not to run the risk of colliding with any type of objects.

Additionally or alternatively, models in the form of state space representations (differential equations), transfer functions, ARMA or ARMAX models (or the like) can be identified by means of special methods (optimization, subspace methods, etc.).

Furthermore, the building material system 1 and/or the distributor boom 3 include/includes a pivot mechanism 5 and/or pivot joints 6a, 6b, 6c, 6d for adjusting the boom segments 3a-d. Additionally or alternatively, the output signals OS are representative of rotational angle positions WSa, WSb, WSc, WSd, WSe, in particular and rotational angle positioning speeds, of the boom segments 3a-d, in particular for the identification of the boom model 3M. In particular, the output signals OS are the rotational angle positions WSa-e, in particular and the rotational angle positioning speeds. Furthermore, additionally or alternatively, the controller RE includes a rotational angle controller WRE. In particular, the controller RE is the rotational angle controller WRE.

In the exemplary embodiment shown, the building material system 1 and/or the distributor boom 3 include/includes four pivot joints 6a-d. In alternative exemplary embodiments, the building material system and/or the distributor boom can include at least three pivot joints.

In detail, the building material system 1 includes the pivot mechanism 5 and an inertial sensor device 9. The inertial sensor device 9 is arranged at an end 3S of the distributor boom 3 opposite to the pivot mechanism 5, in particular the parallel robot 7, and/or the discharge device 2 for the detection of an output signal OS caused by a movement excited by a rotation of the pivot mechanism 5.

In addition, the detection of an output signal OS caused by the excited movements of the parallel robot 7 is performed by means of an optical measuring device 8, in particular a laser tracker 8′.

In other words, actuation signals of valves can be referred to as input signals of the distributor boom. In the parallel robot, it can be a position specification. The respective arm angle can be the output signal in the distributor boom and the current position in the global coordinate system can be the output signal in the parallel robot.

Furthermore, the discharge device 2 includes a printhead 2′. In particular, the discharge device 2 is the printhead 2′. The printhead 2′ is designed to discharge building material BS from the building material system 1 and to shape building material BS to form a strand ST of building material BS, in particular for 3D printing of a structural part BWT, in particular it discharges and shapes and thus forms, in particular prints the building material. This is shown in FIG. 3.

Moreover, step c) includes: controlling the building material system 1 depending on data DBWT of the structural part BWT to be built, in particular to be printed, in particular to travel along specified trajectories.

Furthermore, the method includes the following step: discharging building material BS by means of the discharge device 2 during the control of the building material system 1, in particular for the positioning of the discharge device 2, to distribute building material BS.

Moreover, the building material system 1 includes a conveyor line 10. The conveyor line 10 is arranged along the distributor boom 3 for guiding building material BS to the discharge device 2. Additionally or alternatively, the building material system 1 includes a building material pump 11. The building material pump 11 is designed to convey, in particular conveys, building material BS, in particular through the conveyor line 10, to the discharge device 2. In particular, the method includes the following step: conveying building material BS by means of the building material pump 11 during the control of the building material system 1, in particular for the positioning of the discharge device 2.

Moreover, the discharge device 2, the distributor boom 3, the drive devices 4a-h, the parallel robot 7, the inertial sensor device 9, the measuring device 8, and/or the building material pump 11 are/is designed, in particular respectively, to interact, in particular interact, with the identification, determination, and control device 13.

Furthermore, the distributor boom 3 has a positioning accuracy 3PG of at least 500 mm and/or at most 10 mm, and/or the distributor boom 3 has a range 3R of at least 10 m (meters) and/or of at most 100 m, and/or the distributor boom 3 has a maximum speed 3vmax of at least 10 mm/s (millimeters per second) and/or at most 2 m/s (meters per second), and/or the distributor boom has a maximum acceleration and/or deceleration 3amax of at least 1 m/s² (meters per second per second) and/or at most 20 m/s², and/or the parallel robot 7 has a positioning accuracy 7PG of at least 50 mm and/or at most 0.1 mm, in particular at most 1 mm, and/or the parallel robot 7 has a range 7R of at least 10 mm, in particular at least 100 mm, and/or at most 1000 mm, in particular at most 500 mm, and/or the parallel robot 7 has a maximum speed 7vmax of at least 10 mm/s and/or at most 10 m/s, and/or the parallel robot 7 has a maximum acceleration and/or deceleration 7amax of at least 0.1 m/s² and/or at most 500 m/s².

As the exemplary embodiments shown and explained above make clear, the invention is based on an advantageous method and an advantageous system, each for operating a building material system, each of which has improved properties.

1-15. (canceled)

16. A method for operating a building material system,
wherein the building material system includes a discharge device, a distributor boom, and actuatable drive devices,
wherein the discharge device is designed for discharging building material from the building material system,
wherein the distributor boom includes adjustable boom segments for positioning the discharge device, and
wherein the actuatable drive devices are designed for driving the boom segments,
the method comprising the steps of:
a) identifying a model of the building material system by actuating the drive devices using input signals to excite movements of the distributor boom and by detecting output signals caused by the excited movements;
b) determining a controller depending on the identified model; and
c) controlling, via the determined controller, the building material system to reach and/or maintain a target position of the distributor boom.

17. The method as claimed in claim 16, wherein
the input signals excite a frequency spectrum of the distributor boom.

18. The method as claimed in claim 16, wherein
the input signals include jumps of differing duration and/or differing amplitude.

19. The method as claimed in claim 16, wherein
step a) is performed for various positions of the distributor boom and/or for various loads of the distributor boom with building material to identify different models of the building material system, and
step b) comprises: determining a single controller depending on the identified models.

20. The method as claimed in claim 16, wherein at least one of:
step a) is performed via a second controller simpler than the controller determined in step b),
the model includes a linear model, or
the controller determined in step b) includes a linear controller.

21. The method as claimed in claim 20, wherein
the second controller is a P controller,
the linear controller is an LQ controller, an LQG controller, an LPV controller, an H-infinite controller, and/or a model-predictive controller.

22. The method as claimed in claim 16, wherein at least one of:
the building material system and/or the distributor boom include/includes a pivot mechanism and/or pivot joints for adjusting the boom segments,
the output signals are representative of rotational angle positions and rotational angle positioning speeds of the boom segments, or
the controller includes a rotational angle controller.

23. The method as claimed in claim 16,
wherein the building material system includes a parallel robot,
wherein the distributor boom is designed for positioning the parallel robot at a boom tip of the distributor boom,
wherein the parallel robot is designed for positioning the discharge device,
wherein the actuatable drive devices are designed for driving the parallel robot,
wherein step a) comprises: identifying at least the model of the building material system via the actuation of the drive devices using the input signals to excite movements of the parallel robot and via the detection of the output signals caused by the excited movements, wherein the output signals are representative of a position and/or an alignment of the parallel robot and/or the discharge device with respect to a building environment of the building material system,
wherein step b) comprises: determining at least the controller depending on at least the identified model, and
wherein step c) comprises: controlling, via at least the determined controller, the building material system to reach and/or maintain a target position and/or a target alignment of the parallel robot.

24. The method as claimed in claim 23, wherein
the detection of an output signal caused by the excited movements of the parallel robot is performed by an optical measuring device.

25. The method as claimed in claim 23,
wherein step b) comprises:
determining the controller for the controlling of the distributor boom for the positioning of the discharge device such that the parallel robot reaches its center position and/or its center alignment,
wherein step a) comprises:
identifying the model including a boom model of the distributor boom and a robot model of the parallel robot,
wherein step b) further comprises:
determining a boom controller for controlling the distributor boom depending on the identified boom model and a robot controller for controlling the parallel robot depending on the identified robot model,
identifying a system model of the building material system via actuation of the drive devices using input signals determining a tip position of the boom tip by the determined boom controller, while the parallel robot is controlled by the determined robot controller to reach a target position of the discharge device, and by detection of output signals including a deviation of an actual position of the parallel robot from the center position and/or an actual alignment of the parallel robot from the center alignment,
determining the controller depending on the identified system model, and
wherein step c) comprises:
controlling the parallel robot for the positioning of the discharge device by the determined robot controller.

26. The method as claimed in claim 22, wherein
the building material system includes the pivot mechanism and an inertial sensor device,
the inertial sensor device is arranged at an end of the distributor boom opposite to the pivot mechanism for the detection of an output signal caused by a movement excited by a rotation of the pivot mechanism.

27. The method as claimed in claim 23, wherein
wherein the building material system includes the pivot mechanism and an inertial sensor device, wherein the inertial sensor device is arranged at an end of the distributor boom opposite to the parallel robot, and/or the discharge device for the detection of an output signal caused by a movement excited by a rotation of the pivot mechanism.

28. The method as claimed in claim 16, wherein
the discharge device comprises a printhead,
the printhead is designed for discharging building material from the building material system and for shaping building material to form a strand of building material for 3D printing of a structural part.

29. The method as claimed in claim 28, wherein
step c) comprises: controlling the building material system depending on data of the structural part to be printed.

30. The method as claimed in claim 16, further comprising the step of:
discharging building material by the discharge device during the control of the building material system.

31. The method as claimed in claim 16, wherein
the building material system comprises a conveyor line which is arranged along the distributor boom for guiding building material to the discharge device, and/or
the building material system comprises a building material pump, which is designed for conveying building material, to the discharge device, wherein the method comprises the step of: conveying building material by the building material pump during the control of the building material system.

32. A system for operating a building material system, comprising:
an identification, determination, and control device;
a discharge device;
a distributor boom; and
actuatable drive devices,
wherein the discharge device is designed for discharging building material from the building material system,
wherein the distributor boom includes adjustable boom segments for positioning the discharge device,
wherein the actuatable drive devices are designed for driving the boom segments, and
wherein the identification, determination, and control device is operatively configured to:
a) identify a model of the building material system by actuating the drive devices using input signals to excite movements of the distributor boom and by detecting output signals caused by the excited movements;
b) determine a controller depending on the identified model; and
c) control the building material system to reach and/or maintain a target position of the distributor boom, via the determined controller.
